(19) United States
(12) Patent Application Publication
(10) Pub. No.: US 2022/0002125 A1
(43) Pub. Date: Jan. 6, 2022

(54) INDUSTRIAL VEHICLE

(71) Applicant: SHIMADZU CORPORATION, Kyoto (JP)

(72) Inventors: Daisuke GOSHIMA, Kyoto-shi, Kyoto (JP); Shinya YAMAMURA, Kyoto-shi, Kyoto (JP)

(73) Assignee: SHIMADZU CORPORATION, Kyoto (JP)

(21) Appl. No.: 17/291,276

(22) PCT Filed: Nov. 5, 2018
(86) PCT No.: PCT/JP2018/040965

§ 371 Date: Jul. 1, 2021

(51) Int. Cl. B66F 9/075; B66F 9/24

(52) U.S. Cl. CPC B66F 9/07568; B62D 6/003; B66F 9/24

(57) ABSTRACT

An industrial vehicle includes: a steered wheel angle control unit for changing a steered angle of rear wheels so that an angle of a steering handle corresponds to an angle of the rear wheels, based on signals from a steering angle sensor and a steered wheel angle sensor; an angle calculation unit configured to calculate an angle of the rear wheels corresponding to a minimum turning radius at which a vehicle does not turn over based on the gravity center height and a speed of the vehicle; a steered wheel angle limitation unit and a steering angle limitation unit configured to limit and control the angle of the rear wheels based on an angle of the rear wheels corresponding to the minimum turning radius; and a warning notification unit configured to execute a warning notification based on the angle of the rear wheels corresponding to the minimum turning radius.

### TECHNICAL FIELD

The present disclosure relates to an industrial vehicle such as a forklift, including: a main body including steered wheels; a steering handle for operating the steered wheels; and a lifting and lowering member configured to lift and lower a load, and particularly relates to an industrial vehicle including a steer-by-wire type steering system.

### BACKGROUND ART

In such a forklift as an industrial vehicle, a full-hydraulic type power steering device equipped with an Orbitrol (registered trademark of Eaton Corp.) configured to supply hydraulic oil in an amount corresponding to an operation amount of a steering handle to a steering cylinder to steer steered wheels is used. On the other hand, in recent years, as a steering system of a forklift, a steer-by-wire type electric hydraulic power steering has been adopted in which the operation on the steering handle is detected as an electric signal and input to a control device, and a voltage to be supplied to a DC motor for providing power to a hydraulic pressure supply source is controlled by the control device.

When such a forklift turns with an excessively small radius due to abrupt steering operation at a high traveling speed, there is a risk that the vehicle may turn over. For this reason, various techniques for preventing such overturning have been proposed.

Patent Literature 1 discloses a speed regulating device for a forklift, configured to calculate a gravity center and an overturning limit angle of a forklift on the basis of a position and a weight of a load, to calculate an overturning limit speed at which an angle formed by a force in an overturning direction of the forklift applied to the gravity center and a predetermined direction is the overturning limit angle, on the basis of the gravity center, a steering amount, and the weight of the load, and to regulate the vehicle speed of the forklift on the basis of the overturning limit speed.

Patent Literature 2 discloses a forklift configured to predict a traveling state at a predetermined time of future, to apply a brake in a case where a vehicle speed at that time exceeds an allowable vehicle speed at which an overturning possibly occurs, and to release the brake when the forklift is brought back to a state where the forklift does not turn over.

Patent Literature 3 discloses an overturning prevention device for a forklift, including a lifting height detector configured to detect a lifting height of a fork, a shift amount detector configured to detect a side-shift amount of the fork, and a controller configured to control a traveling speed of a vehicle by arithmetically controlling an operation of a traveling motor based on lifting height data from the lifting height detector and shift amount data from the shift amount detector.

Patent Literature 4 discloses a safety device for a forklift, which includes an electric power steering device configured to supply assist torque to a steering handle by an electric motor. The safety device controls the power steering electric motor so as to reduce the assist torque when the vehicle speed is high and the angular speed of the steered wheel is large, thereby making the steering handle operation heavier to prevent high-speed steering handle operation.

### CITATION LIST

### Patent Literature

Patent Literature 1: JP H10-175800 A

Patent Literature 2: WO 2007/081020 A

Patent Literature 3: JP 2000-72396 A

Patent Literature 4: JP H03-295768 A

### SUMMARY

### Technical Problem

In the disclosures described in Patent Literatures 1 to 3, since overturning is prevented by reducing the speed of the forklift, workability of the forklift is deteriorated. Further, in the disclosures described in Patent Literatures 1 to 4, when abrupt steering is made and turning with an excessively small radius is done before the traveling speed decreases, overturning may occur before the traveling speed decreases.

The present disclosure has been made to solve the above problems, and an object of the present disclosure is to provide an industrial vehicle capable of reliably preventing overturning.

### Solution to Problem

The disclosure is directed to a steer-by-wire type industrial vehicle including: a main body including steered wheels; a steering handle for operating the steered wheels; a lifting and lowering member configured to lift and lower a load; a steering angle sensor configured to detect an angle of the steering handle; a steered wheel angle sensor configured to detect an angle of the steered wheels; and a steered wheel angle control unit configured to change the angle of the steered wheels so that the angle of the steering handle detected by the steering angle sensor corresponds to the angle of the steered wheels detected by the steered wheel angle sensor, the industrial vehicle including: a speed sensor configured to detect a traveling speed of the vehicle; a weight sensor configured to detect a weight of the load; a position sensor configured to detect a height position of the load; and an angle calculation unit configured to calculate the angle of the steered wheels corresponding to a minimum turning radius at which the vehicle does not turn over based on the traveling speed detected by the speed sensor, the weight of the load detected by the weight sensor, and the height position of the load detected by the position sensor; and a steered wheel angle limitation unit configured to limit the angle of the steered wheels based on the angle of the steered wheels corresponding to the minimum turning radius calculated by the angle calculation unit.

The disclosure is directed to the industrial vehicle according to claim 1, which further includes a steering angle limitation unit configured to control the angle of the steering handle based on the angle of the steered wheels corresponding to the minimum turning radius calculated by the angle calculation unit.

The disclosure is directed to the industrial vehicle according to claim 1, which further includes a warning notification unit configured to execute a warning notification based on the angle of the steered wheels corresponding to the minimum turning radius calculated by the angle calculation unit.

### Advantageous Effects of Disclosure

According to the disclosure, since the angle of the steered wheels corresponding to the minimum turning radius at which the vehicle does not turn over is calculated based on the traveling speed detected by the speed sensor, the weight of the load detected by the weight sensor, and the height position of the load detected by the position sensor, and the angle of the steered wheels is limited based on the angle of the steered wheels, it is possible to reliably prevent the overturning of the vehicle.

According to the disclosure, the angle of the steering handle is limited in association with the angle of the steered wheel a movable angle range of the steering angle and a movable angle range of the steering handle can be matched, and it is possible to prevent an erroneous operation by an operator.

According to disclosure, since the warning notification is executed based on the angle of the steered wheels corresponding to the minimum turning radius, it is possible to prevent an erroneous operation by the operator by the warning.

### BRIEF DESCRIPTION OF DRAWINGS

FIG. 1 is a schematic side view of a forklift according to the present disclosure.

FIG. 2 is a front schematic diagram of the forklift according to the present disclosure.

FIG. 3 is a block diagram illustrating a main drive system of the forklift according to the present disclosure.

FIG. 4 is a block diagram illustrating a main control system of the forklift according to the present disclosure.

FIG. 5 is a block diagram illustrating a functional configuration of a control unit 30.

FIG. 6 is a schematic diagram schematically illustrating a traveling speed V(t) and a turning radius r(θ2(t)) of the forklift.

### DESCRIPTION OF EMBODIMENTS

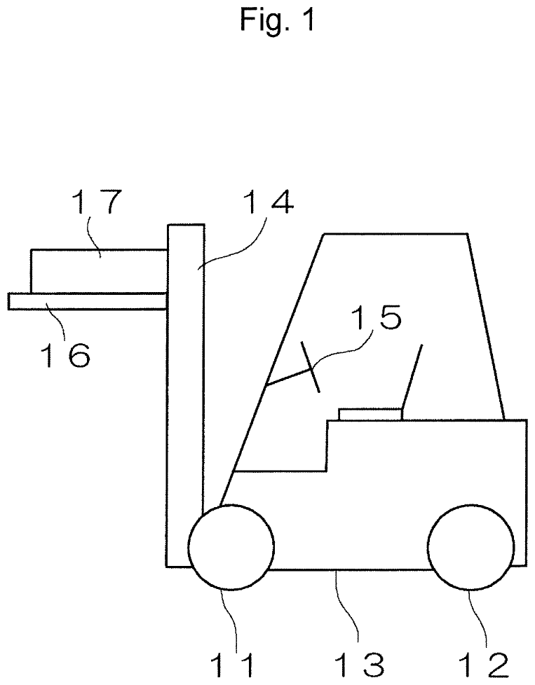

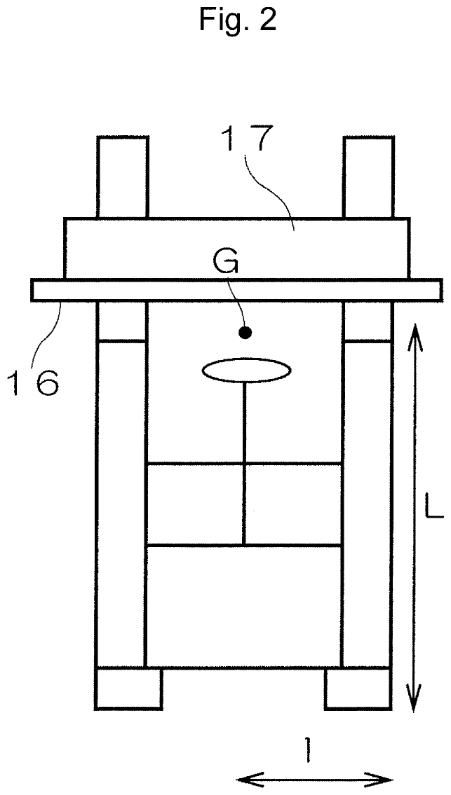

Hereinafter, embodiments of the present disclosure will be described with reference to the drawings. FIG. 1 is a schematic side view of a forklift as an industrial vehicle according to the present disclosure, and FIG. 2 is a schematic front view of the forklift.

The forklift includes a steer-by-wire type steering system, and includes a main body 13 including front wheels 11 as traveling wheels and rear wheels 12 as steered wheels, a steering handle 15 for operating the rear wheels 12, and a fork 16 as a lifting and lowering member configured to lift and lower with respect to a lifting and lowering mechanism 14 disposed on the main body 13 in a state of supporting a load 17.

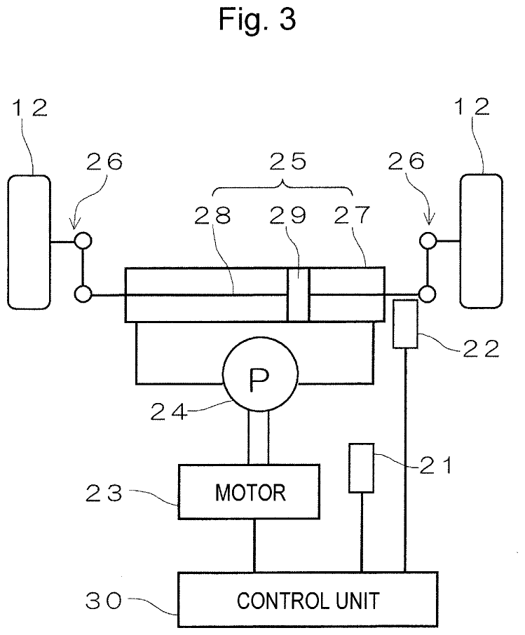

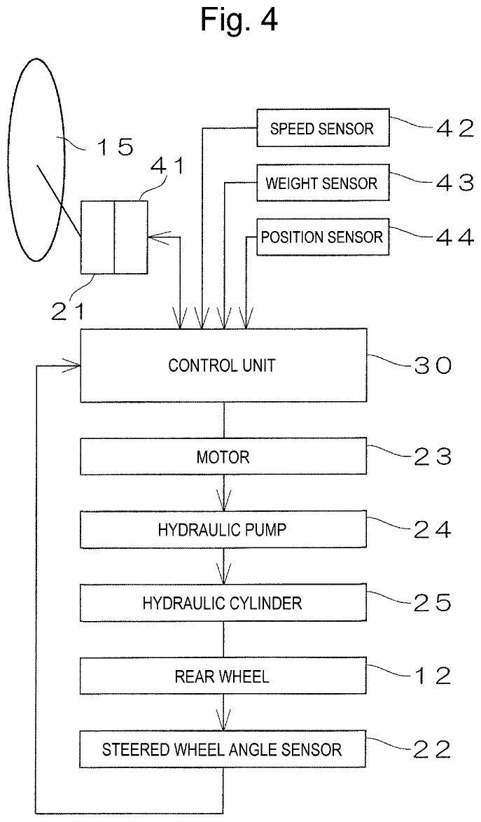

FIG. 3 is a block diagram illustrating a main drive system of the forklift according to the present disclosure. FIG. 4 is a block diagram illustrating a main control system of the forklift according to the present disclosure.

The forklift includes a hydraulic cylinder 25 including a cylinder 27 for changing a steering angle of a pair of the rear wheels 12 as the steered wheels via a knuckle arm 26, a cylinder rod 28, and a piston 29. The forklift also includes a hydraulic pump 24 for supplying hydraulic oil to the hydraulic cylinder 25, a motor 23 configured to rotate the hydraulic pump 24 in forward and reverse directions to actuate the hydraulic cylinder 25, a steering angle sensor 21 for detecting the angle of the steering handle 15, a steered wheel angle sensor 22 for detecting the steering angle of the rear wheels 12, and a brake mechanism 41 configured to regulate rotation of the steering handle 15. The forklift further includes a control unit 30 including a steered wheel angle control unit 31, which will be described later, for changing the steering angle of the rear wheels 12 so that the angle of the steering handle 15 corresponds to an angle of the rear wheels 12, based on signals from the steering angle sensor 21 and the steered wheel angle sensor 22. The control unit 30 is connected to a speed sensor 42 configured to detect a traveling speed of the vehicle (forklift), a weight sensor 43 configured to detect a weight of the load 17, and a position sensor 44 configured to detect a height position of the load 17.

In this forklift, when the steering handle 15 is operated to change its angle, the steering angle sensor 21 detects this change, and transmits a signal indicating the angle of the steering handle 15 to the control unit 30. The control unit 30 rotates the motor 23 based on the signal indicating the angle of the steering handle 15 transmitted from the steering angle sensor 21, actuates the hydraulic cylinder 25 by driving the hydraulic pump 24, and changes the steering angle of the rear wheels 12. The steering angle of the rear wheels 12 is detected by the steered wheel angle sensor 22, and a signal indicating the steering angle is transmitted to the control unit 30. The steered wheel angle control unit 31 in the control unit 30 changes the steering angle of the rear wheels 12 so that the angle of the steering handle 15 corresponds to the angle of the rear wheels 12, based on the signals from the steering angle sensor 21 and the steered wheel angle sensor 22.

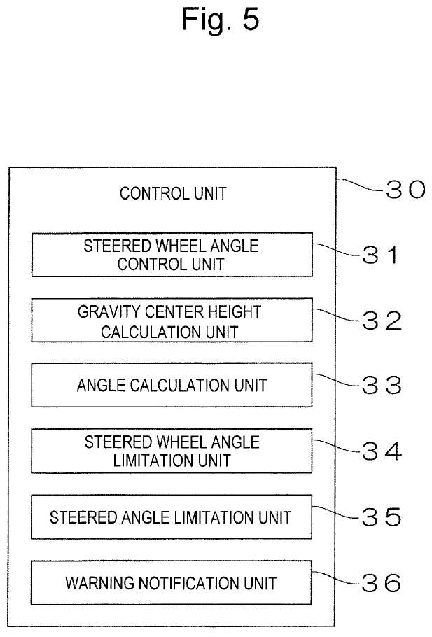

FIG. 5 is a block diagram illustrating a functional configuration of the control unit 30.

The control unit 30 is composed of a computer in which software is installed. The functions of the respective units included in the control unit 30 are achieved by executing the software installed in the computer.

The control unit 30 includes: the steered wheel angle control unit 31, as described above, for changing the steering angle of the rear wheels 12 so that the angle of the steering handle 15 corresponds to the angle of the rear wheels 12, based on the signals from the steering angle sensor 21 and the steered wheel angle sensor 22; a gravity center height calculation unit 32 configured to calculate a gravity center height L obtained by combining the forklift and the load 17 based on a weight M of the load 17 detected by the weight sensor 43 and the height position of the load 17 detected by the position sensor 44; an angle calculation unit 33 configured to calculate an angle θ2(t) of the rear wheels 12 corresponding to a minimum turning radius r(θ2(t)) at which a vehicle does not turn over based on a gravity center height L calculated by the gravity center height calculation unit 32 and a traveling speed V(t) of the vehicle detected by a speed sensor 42; a steered wheel angle limitation unit 34 configured to limit the angle of the rear wheels 12 based on the angle θ2(t) of the rear wheels 12 corresponding to the minimum turning radius r(θ2(t)) calculated by the angle calculation unit 33; a steering angle limitation unit 35 configured to control an angle θ1(t) of the steering handle 15 based on the angle θ2(t) of the rear wheels 12 corresponding to the minimum turning radius r(θ2(t)) calculated by the angle calculation unit 33; and a warning notification unit 36 configured to execute a warning notification based on the angle θ2(t) of the rear wheels 12 corresponding to the minimum turning radius r(θ2(t)) calculated by the angle calculation unit 33. Here, t is time.

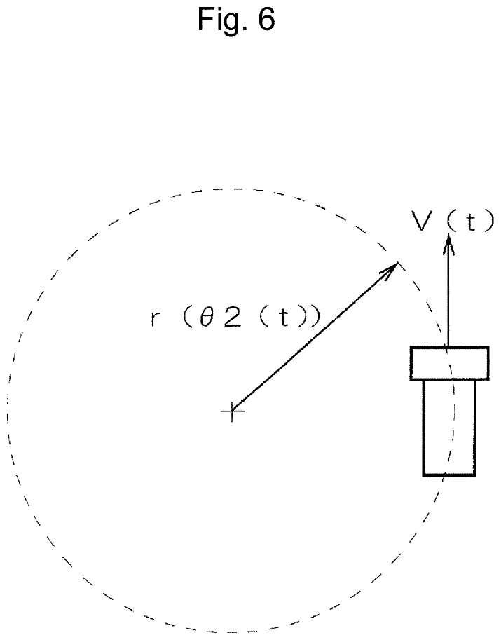

Next, a description will be given of a steered wheel angle limiting operation for limiting the angle of the rear wheels 12 as the steered wheels, in the forklift having the above configuration. FIG. 6 is a schematic diagram schematically illustrating the traveling speed V(t) and the turning radius r(θ2(t)) of the forklift.

A lateral load F(t) to be applied to the forklift during turning is expressed by the following Equation (1), where M is the weight of the load 17, m is a weight of the forklift, v(t) is the traveling speed of the vehicle, r(θ2(t)) is the turning radius, θ2(t) is the angle of the rear wheels 12 as the steered wheels, and t is time.

F(t)=(M+m)×v(t)²/r(θ2(t)) (1)

In addition, as illustrated in FIG. 2, where L is a height of a gravity center G obtained by combining the forklift and the load 17, l is a lateral position of the gravity center G (distance from the gravity center G to an overturning center of the forklift), and g is gravitational acceleration, a relationship of a moment acting on the forklift is expressed by the following Equation (2). Here, the height position of the gravity center G is calculated by the gravity center height calculation unit 32 on the basis of the height position of the load 17 detected by the position sensor 44, the weight of the load 17 detected by the weight sensor 43, the weight of the forklift itself, and the height position of the gravity center G. In addition, the position of the gravity center G in the lateral direction of the forklift is assumed to be a center of the forklift on the assumption that the load 17 is arranged in a central portion of the lateral direction.

F(t)×L=(M+m)×g×1 (2)

When Equation (1) is substituted into Equation (2), the following Equation (3) is obtained.

v(t)²/r(θ2(t))×L=g×1 (3)

Therefore, a condition under which the forklift does not turn over can be expressed by the following Equation (4).

v(t)²/r(θ2(t))×L<g×1 (4)

During traveling of the forklift, the angle θ2(t) of the rear wheels 12 corresponding to the minimum turning radius r(θ2(t)) at which the vehicle does not turn over is calculated by the angle calculation unit 33 in the control unit 30 at the time t. The steered wheel angle limitation unit 34 limits the angle of the rear wheels 12 at each time based on the angle θ2(t) of the rear wheels 12 calculated by the angle calculation unit 33. This makes it possible to prevent the overturning of the forklift in advance.

At this time, in the forklift including the steer-by-wire type steering system, when the above configuration is adopted, a state occurs in which the angle of the rear wheels 12 is not changed even if the operator operates the steering handle 15, and a collision accident or the like may occur due to the operation of the rear wheels 12 against the operator's intention.

Therefore, in the forklift, the steering angle limitation unit 35 in the control unit 30 controls the angle θ1 (t) of the steering handle 15 based on the angle θ2(t) of the rear wheels 12 corresponding to the minimum turning radius calculated by the angle calculation unit 33. More specifically, a range of the angle θ1 (t) of the steering handle 15 is regulated in association with the angle θ2(t) of the rear wheels 12 by the brake mechanism 41 that regulates the rotation of the steering handle 15. In the steer-by-wire type steering system, the brake mechanism 41 is usually disposed to allow the operator to recognize that the hydraulic cylinder 25 for the steering handle 15 is at a stroke end or that the rear wheel 12 is in contact with an obstacle and the steering handle 15 cannot be turned. In the forklift according to the present disclosure, the brake mechanism 41 is used to regulate the range of the angle θ1 (t) of the steering handle 15 in association with the angle θ2(t) of the rear wheels 12.

The warning notification unit 36 in the control unit 30 executes the warning notification based on the angle θ2(t) of the rear wheels 12 corresponding to the minimum turning radius calculated by the angle calculation unit 33. The warning notification may be a warning by sound or light in addition to display of a warning on a display unit.

With these configurations, the operator can recognize that the change of the angle of the rear wheels 12 is limited, and it is possible to prevent an erroneous operation by the operator.

In the embodiments described above, the present disclosure is applied to the forklift on which the load 17 is placed and moved by the fork 16 as the industrial vehicle according to the present disclosure. However, the present disclosure may be applied, for example, to an industrial vehicle, such as a high-place work vehicle, for executing work at a high place with a worker as a load.

### REFERENCE SIGNS LIST

11 . . . Front Wheel
12 . . . Rear Wheel
13 . . . Main Body
14 . . . Lifting And Lowering Mechanism
15 . . . Steering Handle
16 . . . Fork
17 . . . Load
21 . . . Steering Angle Sensor
22 . . . Steered Wheel Angle Sensor
23 . . . Motor
24 . . . Hydraulic Pump
25 . . . Hydraulic Cylinder
30 . . . Control Unit
31 . . . Steered Wheel Angle Control Unit
32 . . . Gravity Center Height Calculation Unit
33 . . . Angle Calculation Unit
34 . . . Steered Wheel Angle Limitation Unit
35 . . . Steering Angle Limitation Unit
36 . . . Warning Notification Unit
41 . . . Brake Mechanism
42 . . . Speed Sensor
43 . . . Weight Sensor
44 . . . Position Sensor
G . . . Gravity Center

What is claimed is:

1. A steer-by-wire type industrial vehicle comprising: a main body including steered wheels; a steering handle for operating the steered wheels; a lifting and lowering member configured to lift and lower a load; a steering angle sensor configured to detect an angle of the steering handle; a steered wheel angle sensor configured to detect an angle of the steered wheels; and a steered wheel angle control unit configured to change the angle of the steered wheels so that the angle of the steering handle detected by the steering angle sensor corresponds to the angle of the steered wheels detected by the steered wheel angle sensor,
the industrial vehicle comprising:
a speed sensor configured to detect a traveling speed of the vehicle;
a weight sensor configured to detect a weight of the load;
a position sensor configured to detect a height position of the load;
an angle calculation unit configured to calculate the angle of the steered wheels corresponding to a minimum turning radius at which the vehicle does not turn over based on the traveling speed detected by the speed sensor, the weight of the load detected by the weight sensor, and the height position of the load detected by the position sensor; and
a steered wheel angle limitation unit configured to limit the angle of the steered wheels based on the angle of the steered wheels corresponding to the minimum turning radius calculated by the angle calculation unit.

2. The industrial vehicle according to claim 1, further comprising a steering angle limitation unit configured to control the angle of the steering handle based on the angle of the steered wheels corresponding to the minimum turning radius calculated by the angle calculation unit.

3. The industrial vehicle according to claim 1, further comprising a warning notification unit configured to execute a warning notification based on the angle of the steered wheels corresponding to the minimum turning radius calculated by the angle calculation unit.
